(19) United States
(12) Patent Application Publication
(10) Pub. No.: US 2019/0313663 A1
(43) Pub. Date: Oct. 17, 2019

(54) CHEWING GUM COMPOSITION AND METHOD OF SHAPING CHEWING GUM IN A 3D PRINTER

(71) Applicant: WACKER CHEMIE AG, München (DE)

(72) Inventors: Thomas WIMMER, Burghausen (DE); Martin SEIZL, München (DE); Dominik WIHR, Burgkirchen (DE)

(21) Appl. No.: 16/466,016

(22) PCT Filed: May 3, 2017
(86) PCT No.: PCT/EP2017/060499

§ 371 Date: Jun. 1, 2019

(51) Int. Cl. A23G 4/20; A23G 4/06; A23G 4/08; A23G 4/10

(52) U.S. Cl. CPC A23G 4/20; A23G 4/064; A23G 4/04; A23G 4/08; A23G 4/10; A23G 4/066

(57) ABSTRACT

The invention relates to a chewing gum composition comprising, calculated as dry weight, 30-60 wt. % maltitol, 5 −30 wt. % mannitol, 5-25 wt. % polyvinylacetate, 1-15 wt. % vinyl acetate-vinyl laurate copolymer, 0.5-5 wt. % gelling agent, 1-7 wt. % of at least one emulsifier. 0.1 ) wt. % trisectine and 1-10 wt. % fat, and with respect to the total weight of the chewing gum composition 4-15 wt. % water. The invention also relates to a print method in which said chewing gum composition is heated in cartridge in a heated print head and thus a three-dimensional object is printed in layers.

The invention relates to a chewing gum composition and to a method for forming chewing gum by additive manufacturing, also known as 3-D printing.

In 3-D printing, three-dimensional objects are constructed layerwise from two-dimensional structures with computer assistance. 3-D printing/additive manufacturing of edible substances is known. WO2014/190168 describes a 3-D printer where printing can proceed from a plurality of heatable cartridges using individual printing compositions. US2016/0106142 describes a system where meals may be produced. individually and automatically on demand. Various concepts for 3-D printing in the foodstuffs sector are described in tabulated form in “The World of Food Ingredients”, CNS Media By, Arnhem, Netherlands; September 2016 edition, page 41. 3D-printed chewing gum is presented at https://3dprint.com/44851/gumjet-3d-printer/. Objects are produced by layerwise extrusion. The disadvantage here is visible separation into different phases associated with poor optical resolution.

The invention has for its object to provide a chewing gum composition which is particularly suitable for forming 3-D printed chewing gum.

The object is achieved by a chewing gum composition which. contains, based on dry matter, 5-50% by weight of maltitol, 5-30% by weight of mannitol, 5-25% by weight of polyvinyl acetate, 1-15% by weight of vinyl acetate-vinyl laurate copolymer, 0.5-5% by weight of gelling agent, 1-7% by weight of at least one emulsifier, 0.1-3% by weight of triacetin and 1-10% by weight of fat and also, based on the total weight of the chewing gum composition, 4-15% by weight of water.

It is preferable when the chewing gum composition contains, based on dry matter, 15-30% by weight of maltitol, 10-25% by weight of mannitol, 12-25% by weight of polyvinyl acetate, 3-15% by weight of vinyl acetate-vinyl laurate copolymer, 2-4% by weight of gelling agent, 2-6% by weight of at least one emulsifier, 1-3% by weight of triacetin and 2-8% by weight of fat and also, based on the total weight of the chewing gum composition, 4-15 by weight of water.

The composition according to the invention makes it possible to three-dimensional objects in markedly higher optical resolution using known per se 3-D printing processes under defined conditions. The resolution may be defined for example via layer thickness. The composition according to the invention makes it possible to realize in 3-D printing layer thicknesses of less than 1 mm.

The chewing gum composition according to the invention preferably contains 6-12% by weight, particularly preferably 8-11% by weight, of water based on the total weight of the chewing gum composition.

The chewing gum composition optionally also contains isomaltulose (Palatinose), aromas customary for a chewing gum, acids (for example citric acid, tartaric acid, malic acid) and also colorings and humectants permitted in foodstuffs. It is preferable when isomaltulose is present in the chewing gum composition according to the invention.

The chewing gum composition preferably contains no further constituents.

Preference is given to polyvinyl acetates having a weight-average molecular weight Mw of 10 000 to 60000, particularly preferably 15 000 to 50 000.

The weight-average molecular weight Mw was determined by size exclusion chromatography (SEC) against polystyrene standard in tetrahydrofuran (THF) at 40° C., flow rate 1.2 ml/min. Mixtures of polyvinyl acetates having different molecular weights may also be employed.

The vinyl laurate-vinyl acetate copolymer preferably has a weight-average molecular weight Mw of 50000 to 600000, particularly preferably 100000 to 400000. The vinyl laurate-vinyl acetate copolymer preferably contains 10% to 50% by weight of vinyl laurate units and 50% to 90% by weight of vinyl acetate units, particularly preferably 15-25% by weight of vinyl lacerate units and 75% to 85% by weight of vinyl acetate units. It is also possible to employ a plurality of vinyl laurate-vinyl acetate copolymers having different copolymer compositions and/or different molecular weights.

Maltitol, a sugar substitute, is a disaccharide from the group of the polyols which is obtained by hydrogenation of maltose. It is commercially available also in the form of highly concentrated maltitol syrup produced by hydrogenation of starch. hydrolysates. This product contains 50-80% by weight of maltitol based on dry matter. Mannitol is likewise: used as a sugar substitute (E 421). It is produced by hydrogenation of fructose.

Contemplated fats include animal fats such as for example tallow and lard and also vegetable fats and oils, for example cocoa butter, palm oil, palm kernel oil, peanut oil, canola oil olive oil, soybean oil, cottonseed oil, which may also be hardened. The vegetable oils may also be fully or partially hydrogenated.

Gelling agents are: substances which swell in water or bind water. Suitable gelling agents are for example gelatine, alginates, carrageenan, cellulose derivatives, pectin, modified starches. Gelatine is particularly suitable. Gelatine is a substance mixture of flavor-neutral animal proteins. The main constituent is denatured/hydrolyzed collagen obtained from the connective tissue of various animal species, in particular pigs and cows.

Suitable emulsifiers are substances customary in the foodstuffs sector such as for example lecithins, sucrose esters, glycerol esters of fatty acids (additive: E471), acetylated glycerol esters of fatty acids (E472a), acetylated monoglycerides such as for example lactic acid monoglycerides (E 472 b), citric acid monoglycerides (E 472 c), tartaric acid monoglycerides (E 472 d) and diacetyltartaric acid monoglycerides (E472 e). Particularly suitable are lecithin, glycerol esters of fatty acids (additive: E471), acetylated glycerol esters of fatty acids (E472a).

Triacetin or glycerol triacetate is a permitted food additive (E1518) and is used in chewing gum or as a carrier for aromas.

Isomaltulose is obtained by fermentation from beet sugar and is marketed under the name Palatinose. Preference is given to a concentration in the chewing gum composition, based on dry matter, of 1-45% by weight, particularly preferably of 10-40% by weight.

Suitable humectants are glycerol, sorbitol or mixtures thereof. Sorbitol is obtainable as a crystalline solid or as a highly concentrated syrup.

The printable chewing gum composition according to the invention is produced in a boiling process. The polyols are dissolved by addition of a little water with heating. After addition of emulsifiers and fat the composition is heated to a temperature of 125-145° C. and boiled. The final moisture content in the product may be ad lusted by means of the boiling temperature. The two polymers (PVAc, VA-VL copolymer) are then added and homogeneously mixed. The polymers may also be used in premixed form. The composition is then cooled to 80-110° C., preferably to 90-100° C. The gelling agent pre-swollen and dissolved in water is subsequently stirred in. Aromas customary in the confectionery sector, for example mint and fruit aromas, and optionally food acids (for example citric, tartaric or malic acid) and colorings, sweeteners (for example acesulfame, aspartame, aspartame-acesulfame salt, cyclamate, saccharin, sucralose, thaumatin, neohesperidin, neotame, steviosides) and humectants (for example glycerol or sorbitol) may be mixed in. The aromas used may be oil-soluble or water-soluble. It is preferable: to employ oil-soluble aromas. The chewing gum is shaped as desired by rolling and cutting or extrusion, and packaged.

The invention further relates to a printing process in which the chewing gum composition according to the invention is heated in a cartridge in a heated printing head and used to print a three-dimensional object in layers.

To perform the 3-D printing process the composition according to the invention is filled into suitable cartridges and printed. Suitable printers for the 3-D printing include known commercially available printers such as for example the Bocusini® 3-D Food printing system from Print2Taste GmbH. The Bocusini® system is based on a 3-D plastics printer from. Printrbot. In this system the cartridge is brought to a defined temperature, preferably 50-95° C., and the cartridge contents are ejected by a piston. The printing table moves in the x, y-direction while the cartridge may be controlled in its z-axis. The printed objects are thus constructed layer by layer. The cartridge contents are liquid due to the elevated temperature and solidify after the printing operation.

Alternatively possible is the use of the chewing gum composition in granulate form or as a filament. The composition according to the invention is then liquefied in an extruder.

The preferred printing temperature with the chewing gum composition according to the invention is 60-95° C., preferably 80-90° C.

The 3-D printer is controlled by Repetier software for example which is obtainable as firmware and is typically used to control printers featuring “fused deposition modeling” technology. In this FDM process objects are constructed layerwise as a melt layer from plastics filaments. An alternative software package for printer control is Simply3D. So-called STL files in which the geometric parameters of the printed object are prepared serve as templates of objects.

The following examples further elucidate the invention:

### EXAMPLE 1

### Production of a Printable Chewing Gum Composition

300 g of maltitol syrup (Maltidex M16311, Cargill; dry matter 75%, 74.9% Maltitol in dry matter) are mixed with 85 g of mannitol, 40 g of water, 10 g of glycerol, 30 g of palm oil and 3 g of acetylated monoglycerides (Acetem, Danisco) and heated to boiling. The boiling temperature increases upon further heating due to the mixture undergoing concentration. At a temperature of 136° C. 90 g of polyvinyl acetate (average molecular weight Mw=15 000) and 30 g of vinyl acetate-vinyl laurate (VINNAPAS® a B 500/20 VL, Wacker Chemie AG; copolymer of 20% vinyl laurate and 80 vinyl acetate) are added and the mixture is stirred at a temperature of 135-140° C. until a homogeneous mixture is obtained. Subsequently, 5 g of triacetin, 5 g of citric acid, 7 g of lemon aroma and a solution of 13 g of gelatine (beef, 140 bloom) in 20 g of hot water (85° C.) are added and mixed. The still-liquid composition is filled into cartridges.

### EXAMPLE 2

### Production of a Printable Chewing Gum Composition

150 g of maltitol syrup (Maltidex M16311, Cargill; dry matter 75%, 74.9% Maltitol in dry matter) are mixed with 120 g of mannitol, 50 g of water, 10 g of glycerol, 35 g of coconut oil, 3 g of acetylated monoglycerides (Acetem, Danisco), 2 g of lecithin and 4 g of triacetin and heated to boiling. The boiling temperature increases upon further heating due to the mixture undergoing concentration.

At a temperature of 140° C. 75 g of polyvinyl acetate (average molecular weight Mw=25 000) and 45 g of vinyl acetate-vinyl laurate (VINNAPAS® B 500/20 VL, Wacker Chemie AG; copolymer or 20% vinyl is rate and 80 vinyl acetate) are added and the mixture is stirred at a temperature of 140° C. until a homogeneous mixture is obtained. The composition is cooled to 95° C. Subsequently, 6 g of malic acid, 6 g of orange aroma, 1.6 g of sunset yellow FCF (E110) and a solution of 10 g of gelatine (beef, 140 bloom) in 16 g of hot water (85° C.) are added and mixed. The still-liquid composition is filled into cartridges.

### EXAMPLE 3

### Production of a Printable Chewing Gum Composition

175 g of maltitol syrup (Maltidex M16311, Cargill; dry matter 75%, 74.9% Maltitol in dry matter) are mixed with 100 g of mannitol, 50 g of water, 8 g of sorbitol, 38 g of partially hydrogenated canola oil, 2.5 g of acetylated monoglycerides (Acetem, Danisco), 2.5 g or lecithin and heated to boiling. The boiling temperature increases upon further heating due to the mixture undergoing concentration.

At a temperature of 142° C. 75 q of poly in acetate (average molecular weight Mw=25 000) and 45 g of vinyl acetate-vinyl laurate (VINNAPAS® B 500/20 VL, Wacker Chemie AG; copolymer of 20% vinyl laurate and 80% vinyl acetate) are added and the mixture is stirred at a temperature of 140° C. until a homogeneous mixture is obtained. The composition is cooled to 90° C. Subsequently, 5 g of mint oil, 4.5 g of triacetin and a solution of 8 g of gelatine (pork, 200 bloom) in 12 g of hot water (80° C.) are added and mixed. The still-liquid composition is filled into cartridges.

### EXAMPLE 4

### Printing a Three-Dimensional Chewing Gum Using an Inventive Chewing Gum Composition

A cartridge filled with the chewing gum composition from example 1 is installed into a Bocusini® 3-D food printing system from Print2Taste and heated to 85° C. for 30 minutes. The Bocusini® printer is controlled by means of a computer using “Repetier Host” software. The test, object used is a hyperboloid of about 5 cm in height. The. STL file therefor may be obtained from www.thingiverse.com for example. The object may be printed with a layer height of 0.5 mm and the obtained printed object has an attractive shape and is readily chewable.

### EXAMPLE 5

### Producing and Printing a Preferred Chewing Gum Composition Comprising Palatinose

A mixture of 80 g of maltitol syrup (Maltidex M16311, Cargill; dry matter 75%, 74.9% Maltitol in dry matter), 65 g of mannitol, 215 g of Palatinose (Beneo), 26 g of palm oil, 5 p of Acetem, 15 g of glycerol, 3 g of lecithin and 35 g of water is heated to balking and boiled until the temperature of the mixture is 142° C. 100 g of polyvinyl acetate (average molecular weight Mw=15 000) and 20 g of vinyl acetate-vinyl laurate (VINNAPAS® B 500/40 VL, Wacker Chemie AG; copolymer of 40% vinyl laurate and 60% vinyl acetate) are then added and the composition is homogenized.

Subsequently, 7 g of orange aroma, 5 g of triacetin and a solution of 15 g of gelatine (pork, 240 bloom) in 28 g of hot water (85° C.) are added and mixed. The still-liquid composition is filled into cartridges.

A three-dimensional object is printed as described in example 4. The printed object is characterized by an even better optical resolution.

### COMPARATIVE EXAMPLE 1

### Printing a Three-Dimensional Chewing Gum Using a Commercial Chewing Gum Composition

A cartridge suitable for the Bocusini® system is filled with a commercially available mint-flavored, sugar-free: strip chewing gum (Wrigleys Orbit Spearmint). The cartridge is heated to 85° C. for 30 minutes. Printing a three-dimensional object with the. Bocusini® Food Printer is not possible. The printed composition does not form a dimensionally stable article upon multilayered construction, runs and exhibits phase separation. Tests with sugar-containing chewing gum and sugar-containing bubble gum also fail. In both latter cases the viscosity of the compositions at 80-100° C. is too great to allow ejection from the cartridge.

### COMPARATIVE EXAMPLE 2

### Printing a Three-Dimensional Chewing Gum Using a Chewing Gum Composition According to Ex. 5 From US2016-0120205

A mixture of 60 g of mannitol and 270 g of maltitol syrup (dry matter: 70%) are boiled to 140° C. 35 g of polyvinyl acetate (VINNAPAS® B 1.5 sp, average molar mass: 15 000), 42 g of vinyl acetate-vinyl laurate copolymer (VINNAPAS® B 500/20 VL, Wacker Chemie AG; copolymer or 20% vinyl laurate and 80% vinyl acetate) and 10 g of microcrystalline wax are mixed into the hot composition and stirred at 130° C. for 15 minutes. Subsequently, 50 g of palm oil and 5 g of Acetem are added and stirred until a homogeneous composition is formed. 8 g or triacetin, 5 g of glycerol monostearate and 3 g of lecithin are then also added at 115° C. with stirring. After further cooling. to 95° C. a solution of 6 g of gelatine (beef, bloom 140) in 12 g of water is added. Finally, 5 g of orange aroma, 4.5 g of citric acid and 0.3 g of aspartame are mixed in ad the composition is filled into cartridges. The cartridges are installed into the Bocusini® system and heated to 90° C. At this temperature the composition exhibits separation, the fat phase rising to the top. Printing with the 3-D printer was therefore not possible. The experiment had to be aborted.

11. A chewing gum composition containing:
5-50% by weight of maltitol, 5-30% by weight of mannitol 5-25% by weight of polyvinyl acetate, 1-15% by weight of vinyl acetate-vinyl laurate copolymer, 0.5-5% by weight of gelling agent, 1 -7% by weight of at least one emulsifier, 0.1 -3% by weight of triacetin and 1-10% by weight of fat, based on dry matter, 4-15% by weight of water, based on the total weight of the chewing gum composition.

2. The chewing gum composition of claim 1, wherein the chewing gum composition contains, based on dry matter, 15-30% by weight of maltitol, 10-25% by w eight of mannitol. 12-25% by weight of polyvinyl acetate, 3-15% by weight of vinyl acetate-vinyl laurate copolymer, 2-4% by weight of gelling agent. 2-6% by weight of at least one emulsifier, 1-3% by weight of triacetin and 2-8% by weight of fat and also, based on the total weight of the chewing gum composition, 4-15% by weight of water.

3. The chewing gum composition of claim 1, wherein the polyvinyl acetate has a weight-average molecular weight Mw of 10,000 to 60,000, preferably 15,000 to 50,000.

4. The chewing gum composition of claim 1, wherein the vinyl laurate-vinyl acetate copolymer has a weight-average molecular weight Mw of 50,000 to 600,000, particularly preferably 100,000 to 400,000.

5. The chewing gum composition of claim 1, wherein the fat is an animal fat or a vegetable fat or oil.

6. The chewing gum composition of claim 1, wherein the gelling agent is selected from the group consisting of gelatine, alginates, carrageenan, cellulose derivative, pectin and modified starch.

7. The chewing gum composition of claim 1, further containing 1-45% by weight of isomaltulose based on dry matter.

8. A method for producing a printing composition of the chewing gum composition of claim 1, comprising:
dissolving polyols by adding water with heating;
adding emulsifiers and a fat to form a composition;
heating the composition to a temperature of 125-145° C. to boil;
adding a PVAc and a VA-VL copolymer and mixing to form a homogenous mixture;
cooling the homogeneously mixture to 80-110° C.;
stirring in a pre-swollen gelling agent dissolved in water; and optionally,
adding aromas customary in the confectionary sector, food acids and colorings, sweeteners, and humectants.

9. A method for printing the chewing gum composition of claim 1, comprising:
heating the chewing gum composition in a cartridge in a heated printing head: and
printing a three-dimensional object in layers.
